(19) United States
(12) Patent Application Publication
(10) Pub. No.: US 2024/0361144 A1
(43) Pub. Date: Oct. 31, 2024

(54) EXIT SUPPORT METHOD AND EXIT SUPPORT DEVICE

(71) Applicant: Panasonic Automotive Systems Co., Ltd., Kanagawa (JP)

(72) Inventors: Takuma IIDA, Kanagawa Ken (JP); Shota AKAURA, Kanagawa Ken (JP)

(73) Assignee: Panasonic Automotive Systems Co., Ltd., Kanagawa (JP)

(21) Appl. No.: 18/765,423

(22) Filed: Jul. 8, 2024

Related U.S. Application Data
(63) Continuation of application No. PCT/JP2023/000688, filed on Jan. 12, 2023.

(30) Foreign Application Priority Data
Mar. 30, 2022 (JP) 2022-056756

(51) Int. Cl. G01C 21/36

(52) U.S. Cl. CPC G01C 21/3685

(57) ABSTRACT

An exit support method includes: acquiring a feature point present around a vehicle; estimating a positional relation between a current position of the vehicle and an entry region based on the feature point and setting information indicating a positional relation between a position of the entry region and a feature point present around the entry region; moving the vehicle to the entry region based on the positional relation; storing an entry start position of the vehicle at which the vehicle starts to move to the entry region in the setting information; and estimating, assuming that the entry start position stored in the setting information is an exit region of an exit destination, a positional relation between a current position of the vehicle and the exit region based on the feature point. The acquiring the path includes moving the vehicle to the exit region based on the positional relation.

### CROSS-REFERENCE TO RELATED APPLICATIONS

This application is a continuation of International Application No. PCT/JP2023/000688, filed on Jan. 12, 2023 which claims the benefit of priority of the prior Japanese Patent Application No. 2022-056756, filed on Mar. 30, 2022, the entire contents of which are incorporated herein by reference.

### FIELD

Embodiments described herein relate generally to an exit support method and an exit support device.

### BACKGROUND

In the related art, there is known a parking support technique of moving a vehicle by automatic driving at the time of entry of the vehicle. As one of parking support techniques, there is disclosed a technique of storing a parking position (entry position) and calculating a travel path in real time based on a relative position of the parking position and a current position (entry start position) of the vehicle to implement parking (entry) of the vehicle (for example, Japanese Patent Application Laid-open No. 2019-137158).

The present disclosure provides an exit support method and an exit support device having an exit function.

### SUMMARY

An exit support method according to an embodiment of the present disclosure, performed by an exit support device configured to support entry and exit of a vehicle, includes: (a) acquiring a feature point present around the vehicle by using a sensor included in the vehicle; (b) estimating a positional relation between a current position of the vehicle and an entry region as an entry destination of the vehicle, based on the feature point acquired in the (a) acquiring and setting information in which a positional relation between a position of the entry region and a feature point present around the entry region is stored in association with each other; (c) acquiring a path from the current position of the vehicle to the entry region based on the positional relation estimated in the (b) estimating to move the vehicle to the entry region along the path; (d) storing, in the setting information, an entry start position of the vehicle at which the vehicle starts to move to the entry region; and (e) estimating, assuming that the entry start position stored in the setting information is an exit region of an exit destination when an instruction is made to cause the vehicle to exit from the entry region, a positional relation between a current position of the vehicle and the exit region based on the feature point acquired in the (a) acquiring. The (c) acquiring includes acquiring a path from the current position of the vehicle to the exit region based on the positional relation estimated in the (e) estimating to move the vehicle to the exit region along the path.

### BRIEF DESCRIPTION OF THE DRAWINGS

FIG. 1 is a block diagram illustrating an example of a configuration of an exit support device according to an embodiment;

FIG. 2 is a block diagram illustrating an example of a functional configuration of an exit support device 1 according to the embodiment;

FIG. 3 is a flowchart illustrating an example of the entire processing performed by the exit support device according to the embodiment;

FIG. 4 is a flowchart illustrating an example of processing performed by the exit support device according to the embodiment; and

FIG. 5 is a flowchart illustrating an example of processing performed by the exit support device according to the embodiment.

### DETAILED DESCRIPTION

As a scene of using an exit support device according to the present embodiment, exemplified is a scene in a case of causing a vehicle to exit from a parking lot of a house and the like, the scene in which the vehicle exits by automatic traveling after a user causes the vehicle to enter the parking lot.

In this scene, the user instructs the vehicle to enter the parking lot by automatic traveling, and causes the vehicle to enter an entry position such as a parking frame detected by the vehicle. Thereafter, the user may cause the vehicle to exit. However, in a case of causing the vehicle to exit by automatic traveling, there has been the problem that the vehicle cannot generate an exit path and cannot exit by automatic traveling because an exit position of an exit destination cannot be detected.

In a case of entry of the vehicle, the vehicle can determine the entry position by detecting a parking frame, a parking space surrounded by a garage, and the like. On the other hand, in a case of exit of the vehicle, the exit position cannot be detected or determined because a target frame or a characteristic object is not present.

### First Embodiment

### 1. Exit Support Device 1 and Other Configurations

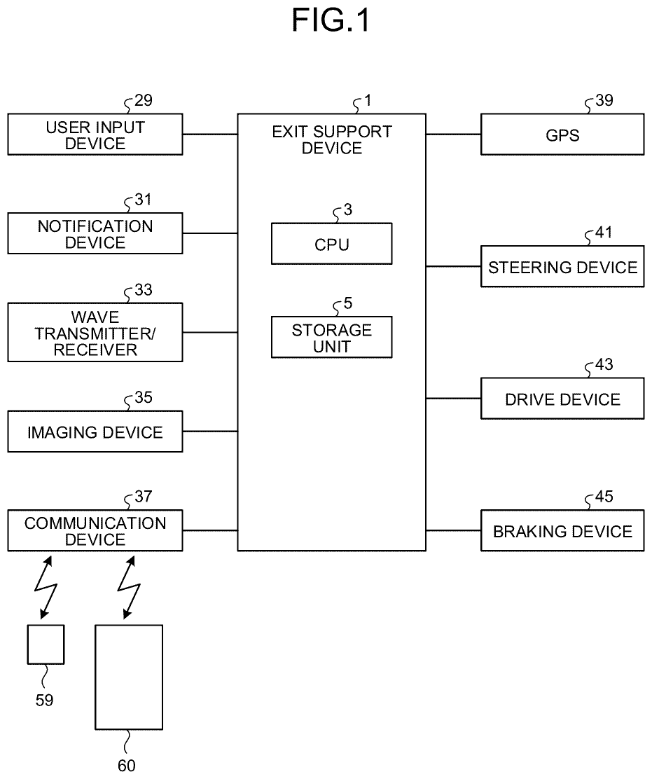

The following describes a configuration of an exit support device 1 based on FIG. 1. The exit support device 1 is an onboard device mounted on a vehicle. The vehicle on which the exit support device 1 is mounted is referred to as an own vehicle hereinafter. As illustrated in FIG. 1, the exit support device 1 is configured as an ordinary computer including a central processing unit (CPU) 3, a read only memory (ROM), and a semiconductor memory (hereinafter also referred to as a storage unit 5) such as a random access memory (RAM) or a read only memory (ROM), for example.

Each function of the exit support device 1 is implemented when the CPU 3 executes a computer program installed in the storage unit 5. Regarding each function of the exit support device 1, when the computer program is executed, a method corresponding to the computer program is executed. The exit support device 1 may include one computer, or may include a plurality of computers.

The storage unit 5 further stores map information. By way of example, as the map information, stored is map information constituted of feature point information such as various three-dimensional structures around the vehicle and texture of a road surface. The map information includes a positional relation X1 between an entry region and a plurality of feature points. The feature point is, for example, part of a contour of a target, and examples thereof include a three-dimensional structure such as a building and texture of a road surface. The entry region is a parking lot and the like in a house, by way of example, and may be a region in which the own vehicle can be parked.

The exit support device 1 creates or corrects the map information. A user cooperates with a user input device 29 to input a position of the entry region. The storage unit 5 stores the input position of the entry region.

As illustrated in FIG. 1, the own vehicle includes the user input device 29, a notification device 31, a wave transmitter/receiver 33, an imaging device 35, a communication device 37, a Global Positioning System (GPS) 39, a steering device 41, a drive device 43, and a braking device 45 in addition to the exit support device 1.

The user input device 29 is disposed in a compartment of the own vehicle. The user input device 29 receives an input from the user. The user input device 29 sends a signal corresponding to the input from the user to the exit support device 1. The user input device 29 may be a portable terminal or a wearable terminal of the user.

By way of example, the notification device 31 is a display device, and the display device is a liquid crystal display or an organic Electro Luminescence (EL) display. The display device may also serve as a touch panel. The display device may be a head-up display that can display an image by projecting the image on a windshield. The notification device 31 may be a speaker or the like that outputs voice, as another example.

The wave transmitter/receiver 33 is a range sensor, by way of example. The range sensor is ultrasonic sonar, by way of example. For example, the ultrasonic sonar emits ultrasonic waves in a case in which the vehicle is traveling in a parking lot, and detects an orientation and a distance to an obstacle present around the vehicle based on reflected waves that have been reflected and detected. The ultrasonic sonar then calculates contour points of the obstacle based on the distance to the obstacle, and detects feature points of the obstacle based on the contour points.

The range sensor is not limited to the ultrasonic sensor, but may be a millimetric wave radar, or Light Detection and Ranging or Laser Imaging Detection and Ranging (LiDAR), for example.

The imaging device 35 is a visible light camera, by way of example. The vehicle includes a first imaging device that images a front side of the vehicle, a second imaging device that images a rear side of the vehicle, a third imaging device that images a left side of the vehicle, and a fourth imaging device that images a right side of the vehicle.

Hereinafter, in a case in which the first imaging device, the second imaging device, the third imaging device, and the fourth imaging device are not required to be particularly distinguished from each other, each of them is simply referred to as the imaging device 35. Although details will be described later, the imaging device 35 is applied to a use of detecting a feature point of an object present around the vehicle, and estimating a current position of the vehicle based on a positional relation between the vehicle and the feature point, for example.

The imaging device 35 outputs a taken image signal to the exit support device 1. The imaging device 35 is not limited to the visible light camera, but may be a Charge Coupled Device (CCD) camera or a Complementary Metal-Oxide Semiconductor (CMOS) camera, for example. The image to be taken may be a static image or a moving image.

The imaging device 35 may be a camera incorporated in the vehicle, or may be a camera of a drive recorder and the like retrofitted to the vehicle. As a sensor for estimating the current position of the vehicle, an ultrasonic sensor, LiDAR, a radar, or the like as a range sensor may be used instead of the imaging device 35.

The communication device 37 performs wireless communication between a terminal 59 outside the own vehicle (by way of example, a smartphone, a tablet terminal, or the like) and a transmission device 60. The GPS 39 acquires positional information of the own vehicle. The GPS 39 outputs the acquired positional information to the exit support device 1.

The steering device 41 steers the own vehicle in response to an instruction of the exit support device 1. The drive device 43 drives the own vehicle in response to an instruction of the exit support device 1. The braking device 45 brakes the own vehicle in response to an instruction of the exit support device 1.

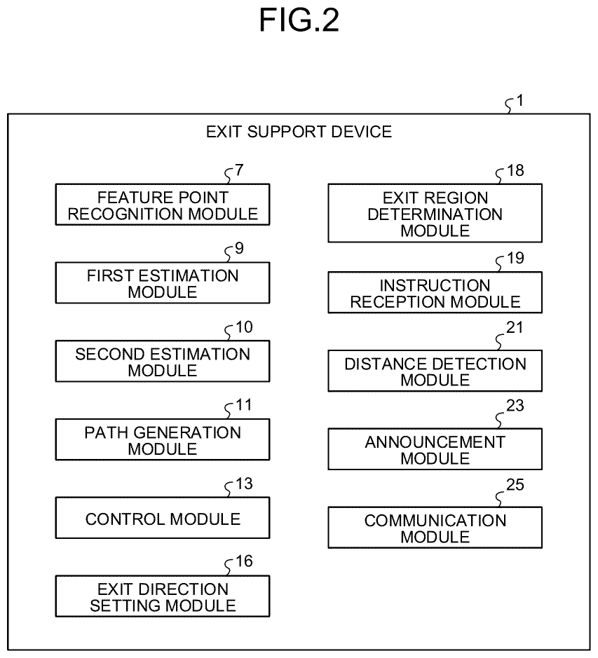

The exit support device 1 includes, as illustrated in FIG. 2, a feature point recognition module 7, a first estimation module 9, a second estimation module 10, a path generation module 11, a control module 13, an exit direction setting module 16, an exit region determination module 18, an instruction reception module 19, a distance detection module 21, an announcement module 23, and a communication module 25.

Some or all of processing of respective functional blocks in the present embodiment may be implemented by computer programs. The pieces of processing in the present embodiment may be implemented by hardware, or may be implemented by software (including an operating system (OS), middleware, or a case in which the processing is implemented with a predetermined library). Furthermore, the processing may be implemented as processing using both of software and hardware.

The feature point recognition module 7 extracts a feature point from a peripheral image taken by the imaging device 35. A method for extracting the feature point by the feature point recognition module 7 is not particularly limited, and a known method can be applied. For example, the feature point recognition module 7 extracts the feature point by using a method such as Features from Accelerated Segment Test (FAST) or Oriented FAST and Rotated BRIEF (ORB).

The feature point recognition module 7 acquires a peripheral feature point Y1 at the time of entry. The feature point recognition module 7 stores the acquired feature point Y1 at the time of entry in the storage unit 5. The feature point recognition module 7 associates the acquired feature point Y1 at the time of entry with an entry start position to be stored in the storage unit 5 as setting information.

The feature point recognition module 7 acquires a relative positional relation (hereinafter also referred to as a positional relation α1) between the own vehicle and the peripheral feature point at the time of entry stored in the storage unit 5. The feature point recognition module 7 then receives the extracted feature point and the feature point stored in the storage unit 5. The feature point recognition module 7 compares the feature point extracted from the taken image with the stored feature point by using pattern matching, feature amount search, and the like.

Furthermore, the feature point recognition module 7 randomly selects several feature points from among feature points that are extracted from the peripheral image and compared with the stored feature point, and estimates the positional relation α1 based on positions of these several feature points in a camera image and three-dimensional positions of these several feature points in real space.

The feature point recognition module 7 acquires a peripheral feature point Y2 at the time of exit. The feature point recognition module 7 stores the acquired feature point Y2 at the time of exit in the storage unit 5. The feature point recognition module 7 also acquires a relative positional relation between the recognized feature point and the own vehicle. Furthermore, the feature point recognition module 7 acquires a relative positional relation α2 between the peripheral feature point at the time of exit and the own vehicle by comparing the feature point Y2 with the positional relation X1.

The first estimation module 9 reads out, from the storage unit 5, the peripheral feature point at the time of entry, and the positional relation X1 between the entry region and a plurality of the feature points. The first estimation module 9 also estimates a relative positional relation Z1 between the own vehicle and the entry region based on the read-put positional relation X1 and the relative positional relation α1 between the peripheral feature point at the time of entry and the own vehicle.

The second estimation module 10 reads out the entry start position from the storage unit 5, and sets the entry start position as an exit region of an exit destination. The second estimation module 10 also reads out, from the storage unit, the positional relation X1 between the recognized feature point and the exit region. The second estimation module 10 also estimates a relative positional relation Z2 between the own vehicle and the exit region based on the read-out positional relation X1 and the positional relation α2.

The feature point recognition module 7 may estimate the position of the own vehicle with respect to each of the feature points by performing pattern matching for the peripheral feature point Y1 at the time of entry and the peripheral feature point Y2 at the time of exit. In other words, the feature point recognition module 7 may estimate the position of the own vehicle with respect to the entry start position by performing pattern matching for the peripheral feature point Y1 at the time of entry and the peripheral feature point Y2 at the time of exit.

The path generation module 11 generates a path from the current position of the own vehicle to the entry region based on the relative positional relation Z1 acquired by the first estimation module 9. As a method for generating the path by the path generation module 11, a known technique can be applied.

The path generation module 11 also generates a path from the current position of the own vehicle to the exit region based on the relative positional relation Z2 acquired by the second estimation module 10.

The control module 13 causes the own vehicle to travel for a predetermined time or by a predetermined distance along the path generated by the path generation module 11. The control module 13 cooperates with the steering device 41, the drive device 43, and the braking device 45 to cause the own vehicle to travel along the path. The control module 13 stores, as the setting information, the entry start position of the vehicle that has started to move to the entry region, and the positional relation between the entry start position and the positions of the entry region and the feature points. The storage unit 5 then stores the entry start position of the vehicle that has started to move to the entry region.

The control module 13 causes the own vehicle to travel for a predetermined time or by a predetermined distance along the path. Furthermore, the control module 13 cooperates with the steering device 41, the drive device 43, and the braking device 45 to cause the own vehicle to travel along the path. The control module 13 also stores, as the setting information, an exit start position of the vehicle that has started to move to the exit region, and a positional relation between the exit start position and the positions of the entry region and the feature points.

The control module 13 controls traveling of the own vehicle in response to a received instruction. Examples of content of the instruction include stopping, restarting, deceleration, acceleration, backward movement, slowing down, and the like of the own vehicle. Furthermore, the control module 13 determines whether the vehicle has completely exited to the exit region.

The exit direction setting module 16 performs processing of determining an exit direction. The exit direction setting module 16 determines whether a default exit orientation is set in advance for the determined exit region. The exit orientation means an orientation of the own vehicle when the own vehicle is caused to exit to the exit region. The exit direction setting module 16 stores an input default exit orientation in the storage unit.

The exit direction setting module 16 also displays a plurality of options on a display 31A. Each of the options corresponds to one exit orientation. Furthermore, the exit direction setting module 16 determines an exit orientation corresponding to an option selected by the user. The exit direction setting module 16 determines the default exit orientation.

The exit region determination module 18 performs exit region determination processing. The exit region determination module 18 also determines whether positions of a plurality of the exit regions are stored in the storage unit. Furthermore, the exit region determination module 18 determines whether a default exit region is set in advance.

The exit region determination module 18 displays a plurality of options on the display 31A. Each of the options corresponds to an exit region. The exit region determination module 18 also determines a single exit region.

The instruction reception module 19 determines whether an instruction to start automatic exit is input to the user input device 29.

The distance detection module 21 cooperates with the GPS 39 to acquire the position of the own vehicle. The distance detection module 21 may store the acquired position of the own vehicle as the entry start position in the storage unit 5.

The announcement module 23 cooperates with the notification device 31 to make an announcement to the user. The user is an occupant of the own vehicle. Content of the announcement is that automatic exit can be started, and prompting the user to input the instruction to start automatic exit. The announcement module 23 cooperates with the notification device 31 to make an announcement about completion of exit to the user.

The communication module 25 cooperates with the communication device 37 to receive the transmitted instruction.

Exit support processing performed by exit support device 1

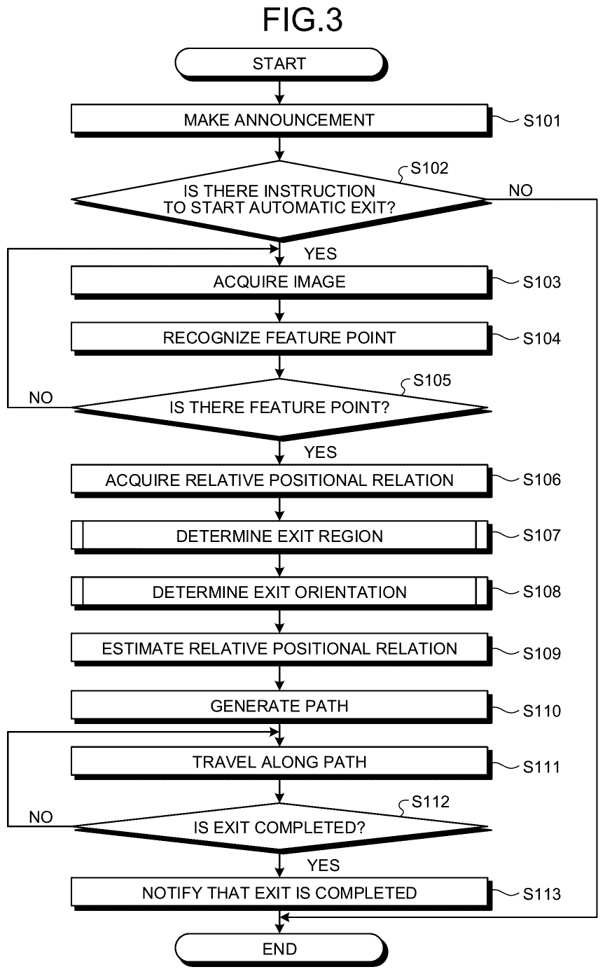

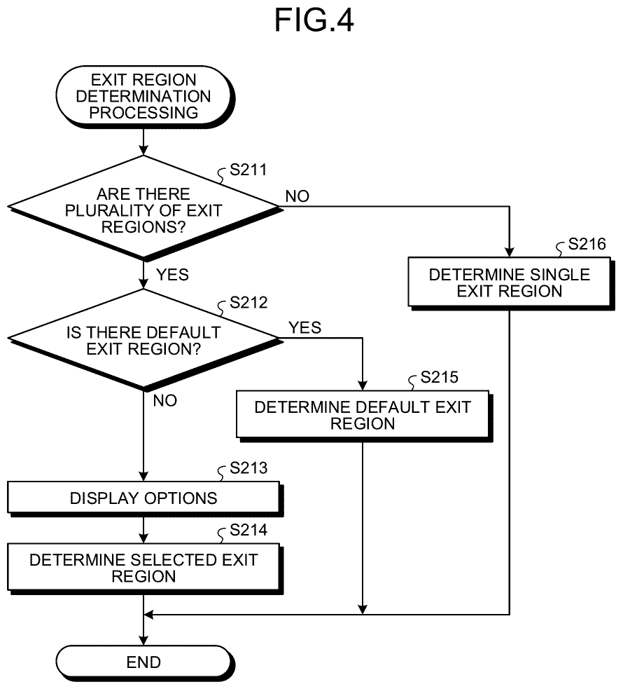

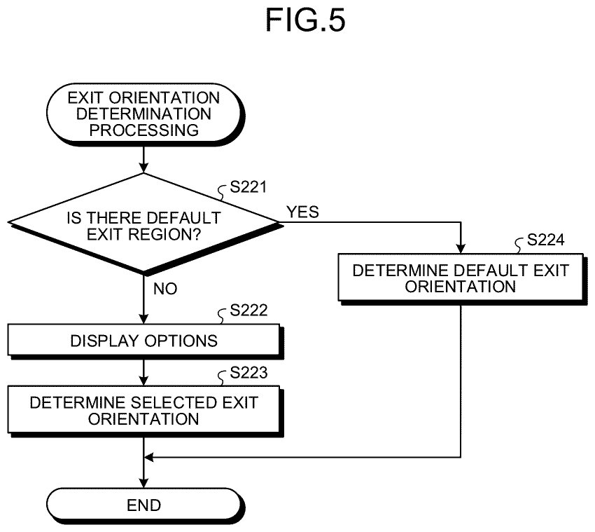

The following describes exit support processing performed by the exit support device 1 based on FIG. 3, FIG. 4, and FIG. 5.

The map information further includes the exit region. The exit region is a region to which the own vehicle can exit. The exit region is the entry start position associated with the feature point Y1 acquired by the feature point recognition module 7 described above. The feature point is part of a target present around the exit region. The feature point is, for example, part of a contour of the target, and examples thereof include a three-dimensional structure such as a building and texture of a road surface.

The exit support device 1 can create or correct the map information. The user can cooperate with the user input device 29 to input the position of the exit region. The storage unit 5 stores the input position of the exit region.

At Step S101, the announcement module 23 cooperates with the notification device 31 to make an announcement to the user. The user can input the instruction to start automatic exit to the user input device 29. The instruction to start automatic exit corresponds to an instruction of the user.

At Step S102, the instruction reception module 19 determines whether the instruction to start automatic exit is input to the user input device 29. The instruction reception module 19 advances the process to Step S103 in a case in which the instruction to start automatic exit is input, and ends this process in a case in which the instruction to start automatic exit is not input. That is, the process proceeds to Step S103 when the instruction to start automatic exit is input as a necessary condition.

At Step S103, the feature point recognition module 7 cooperates with the imaging device 35 to acquire an image representing surroundings of the own vehicle.

At Step S104, the feature point recognition module 7 performs processing of recognizing the feature point in the image acquired at Step S103. The feature point can be recognized by using a well-known image recognition technique. The recognized feature point is assumed to be the feature point Y2. The feature point Y2 includes a position of the feature point in the image, a size of the feature point in the image, an orientation of the feature point in the image, and the like. The feature point recognition module 7 acquires the feature point Y2. The feature point recognition module 7 stores the acquired feature point Y2 in the storage unit 5.

At Step S105, the feature point recognition module 7 determines whether the feature point is recognized in the processing at Step S104. The feature point recognition module 7 advances the process to Step S106 in a case in which the feature point is recognized, and returns the process to Step S103 in a case in which the feature point is not recognized.

At Step S106, the feature point recognition module 7 acquires a relative positional relation between the own vehicle and the feature point recognized in the processing at Step S104. The feature point recognition module 7 can acquire the positional relation α2 by comparing the feature point Y2 with the positional relation X1.

At Step S107, the exit region determination module 18 performs exit region determination processing. The exit region determination processing is described below based on FIG. 4.

At Step S211 in FIG. 4, the exit region determination module 18 determines whether the positions of a plurality of the exit regions are stored in the storage unit 5. The exit region determination module 18 advances the process to Step S212 in a case in which the positions of the exit regions are stored, and advances the process to Step S216 in a case in which a position of a single exit region is stored.

The positions of the exit regions include the entry start position of the vehicle that has started to move to the entry region included in the setting information stored in the storage unit 5 by the control module 13. In a case in which a plurality of automatic entries are performed from different positions, entry start positions (a plurality of the exit regions) of the respective automatic entries may be stored in the storage unit 5.

At Step S212, the exit region determination module 18 determines whether the default exit region is set in advance. The user can cooperate with the user input device 29 to input the default exit region in advance, for example. The default exit region may be caused to be the entry start position of the vehicle that has started to move to the entry region included in the setting information stored in the storage unit 5 by the control module 13 at Step S11.

When the default exit region is input, the exit region determination module 18 stores the input default exit region in the storage unit 5. The process proceeds to Step S213 in a case in which the default exit region is not set, and the process proceeds to Step S215 in a case in which the default exit region is set.

At Step S213, the exit region determination module 18 displays a plurality of options on the display 31A. The user can make an input, to the user input device 29, for selecting any one of the options. Selecting one option by the user corresponds to designation by the user.

At Step S214, the exit region determination module 18 determines the exit region corresponding to the option selected by the user. At Step S215, the exit region determination module 18 determines the default exit region.

At Step S216, the exit region determination module 18 determines a single exit region. Returning to FIG. 3, at Step S108, the exit direction setting module 16 performs exit direction setting processing. This processing is described below based on FIG. 5. At Step S221 in FIG. 5, the exit direction setting module 16 determines whether the default exit orientation is set in advance for the exit region determined at Step S107.

The user can cooperate with the user input device 29 to input the default exit orientation in advance, for example. When the default exit orientation is input, the exit direction setting module 16 stores the input default exit orientation in the storage unit 5. The process proceeds to Step S222 in a case in which the default exit orientation is not set, and the process proceeds to Step S224 in a case in which the default exit orientation is set.

At Step S222, the exit direction setting module 16 displays a plurality of options on the display 31A. The user can make an input, to the user input device 29, for selecting any one of the options. Selecting one option by the user corresponds to designation by the user.

At Step S223, the exit direction setting module 16 determines the exit orientation corresponding to the option selected by the user. At Step S224, the exit direction setting module 16 determines the default exit orientation.

Returning to FIG. 3, at Step S109, the second estimation module 10 first reads out, from the storage unit 5, the positional relation X1 between the feature point recognized in the processing at Step S104 and the exit region determined at Step S108. Next, the second estimation module 10 estimates the relative positional relation 22 between the own vehicle and the exit region determined at Step S108 based on the read-out positional relation X1 and the positional relation α2 acquired at Step S106.

At Step S110, the path generation module 11 generates a path from the position of the own vehicle to the exit region determined at Step S108 based on the relative positional relation Z2 acquired at Step S109. The path generation module 11 generates the path along which the own vehicle is caused to exit to the exit region with the exit orientation determined at Step S108.

At Step S111, the control module 13 causes the own vehicle to travel for a predetermined time or by a predetermined distance along the path acquired at Step S110. The control module 13 cooperates with the steering device 41, the drive device 43, and the braking device 45 to cause the own vehicle to travel along the path. The control module 13 stores, as the setting information, the exit start position of the vehicle that has started to move to the exit region, and a positional relation between the exit start position and the positions of the exit regions and the feature points.

When the own vehicle is traveling along the path, the user may be riding on the own vehicle or may be getting off the own vehicle.

The user can input an instruction to the terminal 59. The terminal 59 transmits the input instruction. The communication module 25 cooperates with the communication device 37 to receive the transmitted instruction. The control module 13 controls traveling of the own vehicle in response to the received instruction.

At Step S112, the control module 13 determines whether the exit to the exit region determined at Step S108 is completed. The control module 13 advances the process to Step S113 in a case in which the exit is completed, and returns the process to Step S111 in a case in which the exit is not completed. At Step S113, the report unit 23 cooperates with the notification device 31 to make an announcement about completion of the exit to the user.

With the exit support device according to the present embodiment, even in a case of causing the vehicle to exit by automatic traveling, the entry start position can be determined to be the exit position by storing the entry start position. Thus, the vehicle can generate an exit path to the exit position and can exit by automatic traveling. In other words, in a case of exit, the vehicle can determine the exit position even if a target frame of the exit destination or a characteristic object is not present, and can exit by automatic traveling.

The exit support device 1 determines the orientation of the own vehicle to exit to the exit region in response to a designation by the user. The exit support device 1 acquires the path so as to cause the own vehicle to exit to the exit region with the determined orientation. Thus, the exit support device 1 can cause the own vehicle to exit to the exit region with the orientation designated by the user.

The exit support device 1 stores the positional relation X1 for each of the exit regions. The exit support device 1 can determine an exit region from among the exit regions in response to the designation by the user. The exit support device 1 estimates the relative positional relation Z2 based on the positional relation X1 corresponding to the determined exit region and the positional relation α2. Thus, the exit support device 1 can cause the own vehicle to exit to the one exit region designated by the user among the exit regions.

At Step S102, if it is determined that the instruction to start automatic exit is input, the exit support device 1 performs Step S103 and the following processing. Thus, automatic exit can be prevented from being performed in a case in which it is not desired by the user.

### Other Embodiments

The embodiment described above can be implemented while being appropriately modified by changing part of the configurations or functions of the respective devices described above. Thus, the following describes some other embodiments related to the embodiment described above. The following mainly describes differences from the embodiment described above, and detailed description will not be repeated about the same points as those in the content that has been already described above. The other embodiments described below may be individually implemented, or may be appropriately combined with each other to be implemented.

In a case of performing automatic exit, the exit support device 1 may make an announcement so that the own vehicle can be recognized from the outside of the own vehicle. The announcement is, for example, lighting of a hazard lamp and the like of the own vehicle. Due to this, safety of the own vehicle and the surroundings of the own vehicle is improved.

At the time of performing automatic exit, the exit support device 1 may cooperate with the wave transmitter/receiver 33 and the like to detect an obstacle, and calculate a risk of colliding with the obstacle for the own vehicle. In a case in which the risk of colliding with the obstacle is higher than a threshold set in advance, the exit support device 1 can cooperate with the notification device 31 to make an announcement to the user boarding on the own vehicle, or can stop the own vehicle.

At the time of performing automatic exit, the exit support device 1 may detect abnormality of behavior of the own vehicle using a known sensor. The abnormality of behavior is that, for example, a tire of the own vehicle is buried in a snow-covered road and the like, and the own vehicle is disabled from traveling. In a case of detecting abnormality of behavior, the exit support device 1 can cooperate with the notification device 31 to make an announcement to the user.

The exit support device 1 may recognize the feature point by using a sensor other than the imaging device 35. The exit support device 1 may acquire the positional relation X1 by using a sensor other than the imaging device 35.

A trigger for performing Step S103 and the following processing may be another trigger. For example, the exit support device 1 can compare information about the image acquired by cooperating with the imaging device 35 with specific information stored in advance, and determine whether the own vehicle is positioned at a specific location set in advance. The specific information is, for example, information about the image acquired by cooperating with the imaging device 35 when the own vehicle is present at the specific location. The exit support device 1 can perform Step S103 and the following processing in a case in which the own vehicle is positioned at the specific location.

The exit support device 1 may perform Step S103 and the following processing when an engine of the own vehicle is started as a trigger. The exit support device 1 may also perform Step S103 and the following processing triggered by an input to the user input device 29 from the user.

The exit support device 1 may store a path from the current position of the own vehicle to the exit region in the storage unit 5 in advance. At Step S101, the exit support device 1 can read out a path matching the current position of the own vehicle and the exit region determined at Step S107 from among stored paths. In a case in which there is no path completely matching the current position of the own vehicle and the exit region determined at Step S107, the exit support device 1 can read out the closest path, and appropriately correct the read-out path to create the path used at Step S111.

Based on the entry start position of the vehicle that has started to move to the entry region and the feature point acquired by the feature point recognition module 7 in a process of moving from the entry start position to the entry region, the exit support device 1 may store a positional relation between the entry start position of the vehicle and the positions of the feature points present around the entry start position of the vehicle in association with each other. The exit support device 1 can update the map information stored in the storage unit 5 by storing the positional relation between the entry start position of the vehicle and the positions of the feature points present around the entry start position of the vehicle in association with each other at the time of entry.

The exit support device 1 may be configured to transmit peripheral feature point information of the own vehicle, the feature point information at the time of entry, and information about the entry start position and the like to a cloud, perform processing (matching processing for the feature point and processing of generating the path to the exit region) of the exit support device according to the present embodiment on the cloud, and transmit the path to the exit region to the exit support device 1 from the cloud.

A plurality of functions of one constituent element in the embodiment described above may be implemented by a plurality of constituent elements, or one function of one constituent element may be implemented by a plurality of constituent elements. A plurality of functions of a plurality of constituent elements may be implemented by one constituent element, or one function implemented by a plurality of constituent elements may be implemented by one constituent element. Part of the configurations of the embodiment described above may be omitted. At least part of the configurations of the embodiment described above may be added to or substituted with the configurations of the other embodiments described above. All aspects included in a technical idea specified from wording described in CLAIMS are embodiments of the present disclosure.

The present disclosure can also be implemented in various forms such as a system including the exit support device as a constituent element, a computer program for causing a computer to function as the exit support device, a recording medium in which the computer program is recorded, an exit support method, a vehicle path generating method, and the like in addition to the exit support device described above.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An exit support method performed by an exit support device configured to support entry and exit of a vehicle, the method comprising:
(a) acquiring a feature point present around the vehicle by using a sensor included in the vehicle;
(b) estimating a positional relation between a current position of the vehicle and an entry region as an entry destination of the vehicle, based on the feature point acquired in the (a) acquiring and setting information in which a positional relation between a position of the entry region and a feature point present around the entry region is stored in association with each other;
(c) acquiring a path from the current position of the vehicle to the entry region based on the positional relation estimated in the (b) estimating to move the vehicle to the entry region along the path;
(d) storing, in the setting information, an entry start position of the vehicle at which the vehicle starts to move to the entry region; and
(e) estimating, assuming that the entry start position stored in the setting information is an exit region of an exit destination when an instruction is made to cause the vehicle to exit from the entry region, a positional relation between a current position of the vehicle and the exit region based on the feature point acquired in the (a) acquiring, wherein
the (c) acquiring includes acquiring a path from the current position of the vehicle to the exit region based on the positional relation estimated in the (e) estimating to move the vehicle to the exit region along the path.

2. The exit support method according to claim 1, further comprising (f) determining an exit orientation in which the vehicle exits to the exit region in response to designation by a user, wherein
the (c) acquiring includes acquiring the path corresponding to the orientation determined in the (f) determining to move the vehicle to the exit region along the path.

3. The exit support method according to claim 1, comprising (g) determining one exit region from among a plurality of the exit regions in response to designation by a user, wherein
the (e) estimating includes estimating the positional relation based on the positional relation corresponding to the exit region determined in the (g) determining and the feature point acquired in the (a) acquiring.

4. The exit support method according to claim 2, comprising (g) determining one exit region from among a plurality of the exit regions in response to designation by a user, wherein
the (e) estimating includes estimating the positional relation based on the positional relation corresponding to the exit region determined in the (g) determining and the feature point acquired in the (a) acquiring.

5. The exit support method according to claim 1, wherein
the (d) storing includes storing the entry start position of the vehicle at which the vehicle starts to move to the entry region and a plurality of feature points present around the entry start position in association with each other, based on the entry start position and the feature points acquired in a process of moving from the entry start position to the entry region.

6. The exit support method according to claim 2, wherein
the (d) storing includes storing the entry start position of the vehicle at which the vehicle starts to move to the entry region and a plurality of feature points present around the entry start position in association with each other, based on the entry start position and the feature points acquired in a process of moving from the entry start position to the entry region.

7. The exit support method according to claim 3, wherein
the (d) storing includes storing the entry start position of the vehicle at which the vehicle starts to move to the entry region and a plurality of feature points present around the entry start position in association with each other, based on the entry start position and the feature points acquired in a process of moving from the entry start position to the entry region.

8. The exit support method according to claim 4, wherein
the (d) storing includes storing the entry start position of the vehicle at which the vehicle starts to move to the entry region and a plurality of feature points present around the entry start position in association with each other, based on the entry start position and the feature points acquired in a process of moving from the entry start position to the entry region.

9. An exit support device configured to support entry and exit of a vehicle, the device comprising:
a memory; and
a processor coupled to the memory and configured to:
(a) acquire a plurality of feature points present around the vehicle by using a sensor included in the vehicle;
(b) estimate a relative positional relation between a current position of the vehicle and an entry region as an entry destination of the vehicle, based on the feature points acquired in the (a) and setting information in which a positional relation between a position of the entry region and positions of a plurality of feature points present around the entry region is stored in association with each other;
(c) acquire a path from the current position of the vehicle to the entry region based on the positional relation estimated in the (b) to move the vehicle to the entry region along the path;
(d) cause the memory to store, in the setting information, an entry start position of the vehicle at which the vehicle starts to move to the entry region and a positional relation between the entry start position and positions of the entry region and the feature points; and
(e) estimate, assuming that the entry start position stored in the setting information in the memory is an exit region of an exit destination when an instruction is made to cause the vehicle to exit from the entry region, a relative positional relation between a current position of the vehicle and the exit region based on the feature points acquired in the (a), wherein
the processor is configured to acquire a path from the current position of the vehicle to the exit region based on the positional relation estimated in the (e) to move the vehicle to move to the exit region along the path.

10. The exit support device according to claim 9, wherein
the processor is further configured to (f) determine an exit orientation in which the vehicle exits to the exit region in response to designation by a user, wherein
the processor is configured to acquire the path corresponding to the orientation determined in the (f) determining to move the vehicle to the exit region along the path.

11. The exit support device according to claim 9, wherein
the processor is further configured to (g) determine one exit region from among a plurality of the exit regions in response to designation by a user, wherein
the processor is configured to estimate the positional relation based on the positional relation corresponding to the exit region determined in the (g) determining and the feature point acquired in the (a) acquiring.

12. The exit support device according to claim 10, wherein
the processor is further configured to (g) determine one exit region from among a plurality of the exit regions in response to designation by a user, wherein
the processor is configured to estimate the positional relation based on the positional relation corresponding to the exit region determined in the (g) determining and the feature point acquired in the (a) acquiring.

13. The exit support device according to claim 9, wherein
the processor is configured to store the entry start position of the vehicle at which the vehicle starts to move to the entry region and a plurality of feature points present around the entry start position in association with each other, based on the entry start position and the feature points acquired in a process of moving from the entry start position to the entry region.

14. The exit support device according to claim 10, wherein
the processor is configured to store the entry start position of the vehicle at which the vehicle starts to move to the entry region and a plurality of feature points present around the entry start position in association with each other, based on the entry start position and the feature points acquired in a process of moving from the entry start position to the entry region.

15. The exit support device according to claim 11, wherein
the processor is configured to store the entry start position of the vehicle at which the vehicle starts to move to the entry region and a plurality of feature points present around the entry start position in association with each other, based on the entry start position and the feature points acquired in a process of moving from the entry start position to the entry region.

16. The exit support device according to claim 12, wherein
the processor is configured to store the entry start position of the vehicle at which the vehicle starts to move to the entry region and a plurality of feature points present around the entry start position in association with each other, based on the entry start position and the feature points acquired in a process of moving from the entry start position to the entry region.
